(19) United States
(12) Patent Application Publication
(10) Pub. No.: US 2001/0031024 A1
(43) Pub. Date: Oct. 18, 2001

(54) Receiver and method for detecting and decoding a DQPSK modulated and channel encoded receiving signal

(76) Inventors: Jurgen Petersen, Nurnberg (DE); Thomas Wagner, Schwabach (DE)

Correspondence Address: Corporate Patent Counsel, U.S. Philips Corporation, 580 White Plains Road, Tarrytown, NY, 10591, US

(21) Appl. No.: 09/794,942

(22) Filed: Feb. 28, 2001

(30) Foreign Application Priority Data
Feb. 29, 2000 (DE) 10009443.0

(51) Int. Cl. H04L 27/14

(52) U.S. Cl. 375/335

(57) ABSTRACT

The invention relates to a transmission system, a receiver and a method for receiving a DQPSK modulated and additionally channel encoded receiving signal. After reception, the receiving signal is demodulated in conformity with the incoherent differential detection principle and channel decoded while taking into account reliability values. According to the invention the channel decoding is enhanced in that the improved reliability values are normalized to a reference quantity that is based on the noise power of the receiving signal.

The invention relates to a receiver and a method of detecting and decoding a DQPSK modulated and channel encoded receiving signal as disclosed in the introductory part of claim 1 and the introductory part of claim 4, respectively.

Transmission systems, notably mobile radio systems, utilizing differential quaternary phase shift keying or DQPSK as the modulation method are known from the state of the art. Examples in this respect are the United States of America mobile radio system IS-136 or the Japanese PDC system.

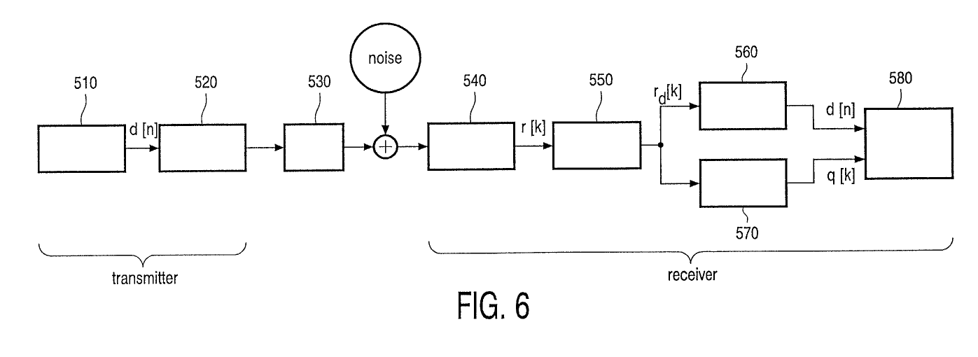

The construction principle of such a transmission system is shown in FIG. 6. A bit generator 510 at the transmitter side generates binary information symbols d[n] which are subsequently modulated by a DQPSK modulator 520. The modulated information signals are transferred via a transmission channel 530 which is usually a mobile radio channel. During a their transmission via the channel 530 the modulated information symbols are disturbed, for example by additive white Gaussian noise.

The information symbols thus disturbed are received by a receiver in which they are first filtered by a receiving filter 540. The DQPSK modulated received information symbols are demodulated in the receiver by means of a so-called differential detection method. In conformity with this method the sampled instantaneous signal values r[k] present at the output of the receiving filter 540 are applied to a phase detector 550 which forms the phase difference between each time two signal values that are spaced the symbol distance Ts apart. Generally speaking, the phase difference is formed by multiplication of the instantaneous signal value r[k] by the conjugate complex preceding signal value r*[k−1]. The phase detector 550 outputs the result of this multiplication as a so-called differentiated signal value rd[k], where rd[k]=r[k]·r*[k−1], which represents the phase angle between the signal values sampled between the instants k−1 and k.

The reconstruction, that is, the detection of the originally transmitted binary information symbol in the receiving channel, is performed in a detection device 560 that succeeds the phase detector 550. The detection device detects an information signal d[n] in conformity with the differential detection principle, that is, on the basis of the differentiated signal value rd[k] presented by the phase detector 550. The detection device outputs the detected, that is, demodulated but still channel encoded, information signal d[n] via its output.

The detection is particularly simple when the binary information signals are mapped on quaternary symbols in conformity with the Gray encoding rule, that is, on phase difference values, upon their modulation in the transmitter, a constant phase shift of π/4 being added to the phase difference values at each symbol clock pulse. This special modulation method is referred to as π/4 DQPSK modulation and results in the relations between binary information symbols and phase difference values that are shown in Table 1.

TABLE 1

| Binary information | Phase difference |
|---|---|
| Symbols | Values |
| 00 | 0° + 45° = 45° |
| 01 | +90° + 45° = 135° |
| 10 | −90° + 45° = −45° |
| 11 | −180° + 45° =−135° |

In the case of such π/4 DQPSK modulation in the transmitter, the binary information symbols can be derived directly by comparison of reel values with a threshold value 0 in the receiver. A comparison of the in-phase signal value, that is, the real component, yields a less significant bit of the binary information symbols whereas a comparison of the quadrature signal value, that is, the imaginary component, with the threshold value 0 yields the more significant bit of the binary information signal. When the phase difference reference values do not lie on the ±45° axes due to the modulation rule, they can be moved to the correct position by way of a constant phase shift (for example, by complex multiplication).

The differential detection of receiving signals in a receiver as described thus far serves merely for the demodulation of information symbols modulated in the transmitter in conformity with the DQPSK modulation method.

In many cases, however, the information symbols in a transmitter are additionally encoded by way of error correction codes so as to achieve additional protection against falsification. It is state of the art in digital mobile radio and satellite systems to use convolution codes for error correction. For the convolution codes efficient decoding methods exist that are capable of advantageously utilizing not only the received binary input symbols but also so-called reliability values (soft decision values), associated with the input symbols, during the decoding (for example, by means of the Viterbi algorithm).

The reliability or soft decision values are a measure as to what extent the binary or hard decisions taken in the receiver actually represent the level of a binary information symbol generated in the transmitter.

For the described differential detection method it is known, for example, from the book “Nachrichtenübertragung” by K. D. Kammeyer, Teubner Verlag, Stuttgart, 1992, to calculate such reliability values on the basis of the real and the imaginary component of the differentiated signal value rd[k]. These reliability values are then q[2]=|Re(rd[k])| and q[2k+1]=|Im(rd[k])|.

It has been found in practice that reliability values thus calculated are usable only if the noise power of the receiving signal may be considered to be approximately constant over adequately long time intervals which are determined by the code word length of the channel code and the interleaving used.

In the case of mobile radio systems with time multiplex TDMA access methods, however, this condition is not satisfied. Therein the receiving levels change, notably in the case of multi-channel propagation via the radio link, in each time slot; the receiver attempts to compensate this by built-in automatic gain control (AGC). This compensation is necessary to enable optimum control of the analog-to-digital converters (ADCs) that are usually present in digital receivers. The different gain values in their turn lead to changing noise powers in the time slots, thus giving rise to different scaling of the reliability values. In conjunction with interleaving, where binary information symbols d[k] and associated reliability values q[k] from different time slots belong to one code word, such different scaling of the reliability values inherently leads to degradation in a channel decoding device of the receiver. Furthermore, such different scaling gives rise to problems during the quantization of the reliability values when their range of variation is to be represented by a respective adequately large number of steps.

The necessity of scaling of the reliability values is known, for example, for the given detection method of the coherent Maximum Likelihood Sequence Estimation MLSE detection; in this respect reference is made to the publication “Soft-Output MLSE for IS-136 TDMA” in 1997, IEEE 6th International Conference on Universal Personal Communications record bridging the way to 21st Century, Vol. 1, pp. 53-57. In the cited article it is proposed to normalize the reliability values in the context of a special detection method, that is, in the context of coherent Maximum Likelihood Sequence Estimation MSLE detection, to the variance of white Gaussian noise in the transmission channel.

The calculation rule for normalized reliability values which is disclosed therein is based on the so-called Log-Likelihood ratios that are derived from the likelihood calculation; reliability values q[k] can then be calculated as follows:

$$q [ k ] = log ( \frac{P ( d [ k ] = 1 \vert r [ k ] )}{P ( d [ k ] = 0 \vert r [ k ] )} ) or q [ k ] = log ( \frac{{p}_{e}}{1 - {p}_{e}} )$$

Therein:

P( ): likelihood of the indicated event

d[k]: binary information symbol with timing pulse k

r[k]: received, sampled signal value with timing pulse k

pₑ: bit error likelihood

Both representations given above are equivalent and interchangeable. This reliability measure offers the advantage that the values in the convolution decoder (Viterbi algorithm) can be simply added in order to form the branching metrics.

Based on this state of the art, it is an object of the present invention to improve a system, a receiver and a method of the kind set forth and suitable for incoherent differential detection in such a manner that a respective reliability value calculated for a single binary information symbol approximates the ideal reliability measure defined above.

This object is achieved as disclosed in the independent claims 1 and 4.

The receiver claimed in claim 1 is characterized in that the reliability values q[k] are normalized to a reference quantity that is based on the noise power of the receiving signal.

This offers the advantage that degradation of the channel decoding device in the receiver upon interleaving is avoided. It also offers the advantage that the reliability values can be quantized with a minimum number of steps. When convolution codes are used for the channel encoding, the normalization of the reliability values also offers the advantage that the information symbols recovered in the convolution decoder exhibit a gain in respect of signal-to-noise ratio of approximately 2 dB in the case of a channel disturbed by additive white Gaussian noise and of from 2 to 5 dB in the case of Flat Rayleigh and Rice Fading channels, that is, in comparison with the use of non-normalized reliability values.

The normalization of reliability values during the differential detection advantageously leads to a slight increase of the complexity only and also to only a slight additional expenditure for the implementation.

The reliability values calculated in conformity with the formule claimed in claim 2 are based on the so-called Log-Likelihood ratios derived from the likelihood calculation. For the processing of the reliability values in the channel decoder this offers the advantage that they can be very simply further processed therein from a mathematical point of view. The reliability values in conformity with claim 2 are normalized to the variance of the noise power of the receiving signal.

The object is also achieved by means of a transmission system, notably a mobile radio system, in which the calculation method proposed for the receivers of the transmission system offers the same advantages for the calculation of reliability values as described for the receiver claimed above.

Finally, the object is also achieved by means of a method as claimed in claim 4; for the method claimed for the calculation of the reliability values again the same advantages are obtained as already described above.

The following description is given with reference to some Figures; therein

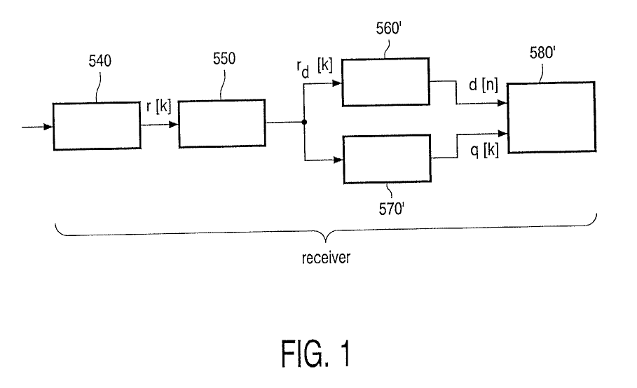

FIG. 1 shows the receiver according to the invention,

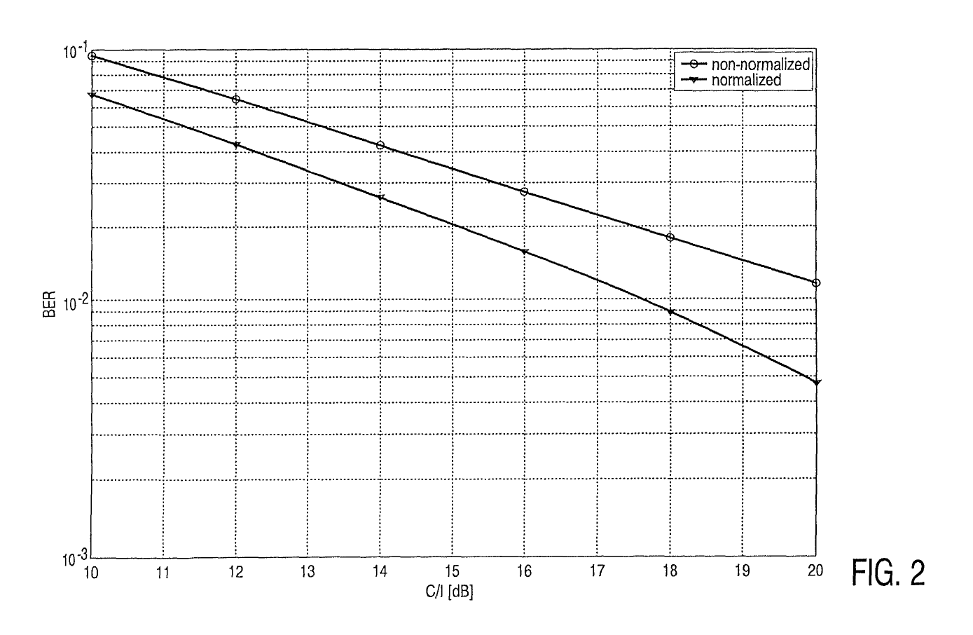

FIG. 2 shows the gain in respect of the bit error ratio when using normalized reliability values in comparison with the use of non-normalized reliability values,

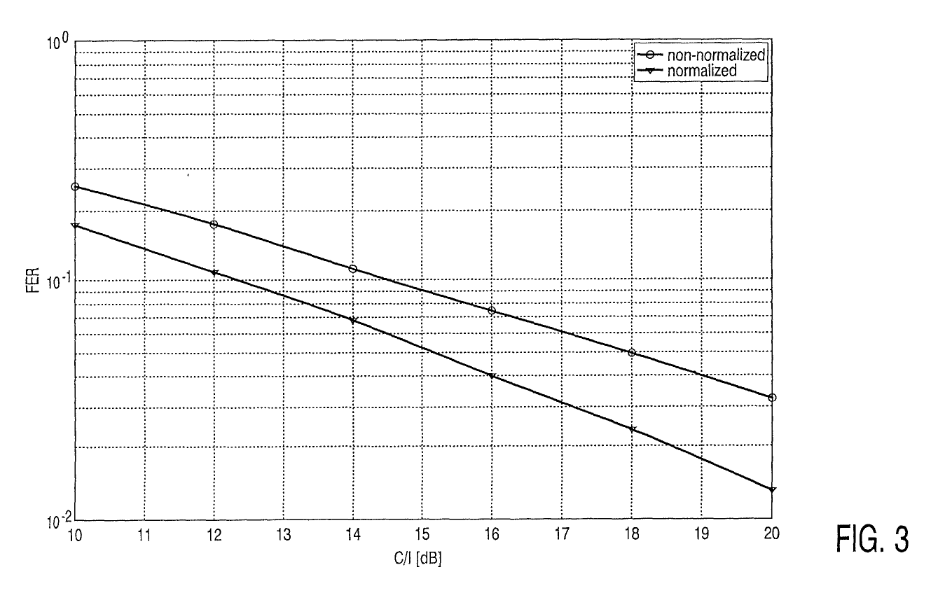

FIG. 3 shows the gain in the frame error ratio when using normalized reliability values in comparison with the use of non-normalized reliability values,

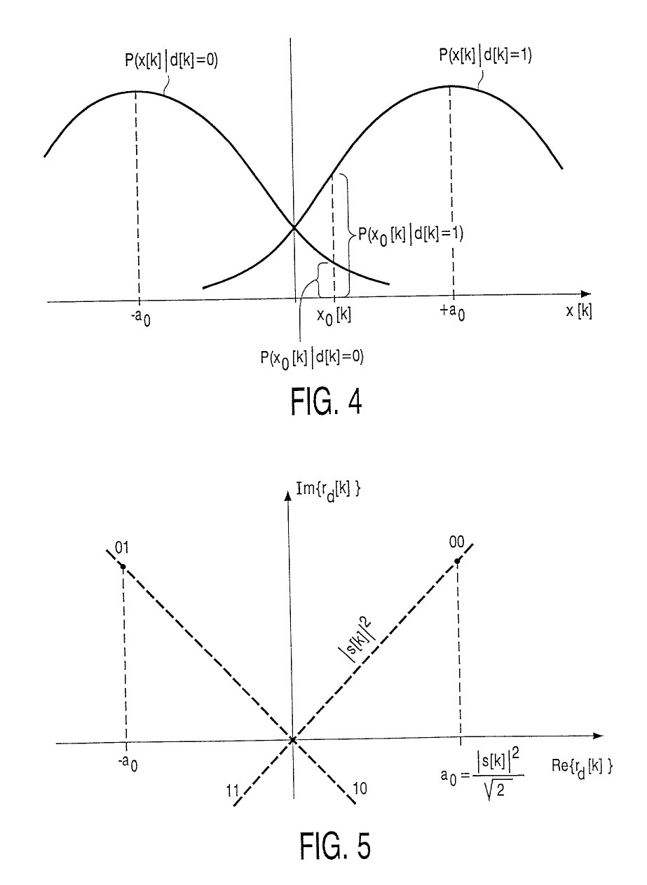

FIG. 4 shows conditional amplitude distribution densities of the receiving signal in the case of a time-invariant channel disturbed by additive white Gaussian noise,

FIG. 5 shows a diagram illustrating the calculation of reliability values for DQPSK modulated signals, and

FIG. 6 shows a transmission system with DQPSK modulation and differential detection in conformity with the state of the art.

The invention will be described in detail hereinafter with reference to the FIGS. 1 to 5.

The construction of the receiver according to the invention that is shown in FIG. 1 basically is similar to that of the receiver 540-580 that is shown in FIG. 6 and is known from the state of the art. Differences therebetween, however, concern the detection device 560, the calculation device 570 and the channel decoding device 580.

The detection device according to the invention does not operate in conformity with the coherent MLSE detection principle, but in conformity with the incoherent differential detection principle.

In order to make a distinction between devices according to the state of the art and devices according to the invention, the references of the latter devices are supplemented by an accent “′”.

In the calculation device 570′ according to the invention the reliability values q[n] are calculated on the basis of the differentiated signal values rd[k], where

rd[k]=r[k]·r*[k−1] (1)

If necessary, the differential signal values rd[k] are multiplied by a rotation factor which would rotate the noise-free signal values rd[k] on the ±45° axis of the signal plane. For the less significant information bit the real component of rd[k] is used as the reliability measure q[n] while for the more significant information bit the imaginary component of rd[k] is used, that is, each time normalized to the noise power Φ_{c}² of the complex receiving signal r[k] and with an arbitrary constant C which preferably has the value \sqrt{2}:

$$\begin{matrix}q [ 2 k ] = C \cdot \frac{Re \{ {r}_{d [ k ]} \}}{{σ}_{c}^{2}} & ( 2 ) \\ q [ 2 k + 1 ] = C \cdot \frac{Im \{ {r}_{d [ k ]} \}}{{σ}_{c}^{2}} & ( 3 )\end{matrix}$$

The reliability values q[k] defined above represent signed numerical values whose sign represents the “hard” binary decision “0” or “1 ” whereas their absolute value represents the reliability of the decision. When the association between the binary information symbols and phase difference values as shown in the Table 1 is used, a negative sign signifies a “0” and a positive sign a “1”. On statistical average a low absolute value represents an uncertain decision and a high absolute value a certain decision.

For the normalization with the noise power Φ_{c}² it is necessary to enable the receiver to estimate the noise power; this is achieved by taking appropriate steps. The receiver must also be capable of determining approximately the position of the optimum sampling instant from the receiving signal. A solution approach commonly used in many systems consists in inserting known symbols (training sequence) at periodic intervals in the data stream to be transmitted. In time slot oriented TDMA systems, generally speaking, a coherent training sequence is provided in the time slot composition with attractive correlation properties for this purpose.

The noise power Φ_{c}² can then be estimated, for example, in such a manner that first the resultant pulse response of the transmission system is determined, from the training sequence, for example, by means of the least squares method that is known from the state of the art, and subsequently the receiving signal within the training sequence is reconstructed by convolution of the pulse response with the complex-valued symbol sequence of the training sequence. The averaging over the error signal between the actually received signal values and the reconstructed signal values then yields an estimated value for the noise power.

The reliability values calculated in conformity with the formules (2) and (3) are applied to the channel decoding device 580′ in accordance with the invention which reliably decodes channel encoded information symbols d[n] while using such normalized reliability values.

The use of the normalized reliability values instead of the non-nornalized reliability values in the case of error correction codes, notably convolution codes, in conjunction with the DQPSK modulation offers an enhanced quality of the decoded information symbol sequences after the channel decoding. Such an enhanced quality becomes manifest notably as a gain in signal-to-noise ratio for the decoded pulse sequences. FIGS. 2 and 3 illustrate the gain achieved when normalized reliability values instead of non-normalized reliability values are used for channels with fading that is not frequency selective and with common channel interference. More exactly speaking, FIG. 2 shows the reduced bit error ratio for a given carrier to interference ratio (C/I) whereas FIG. 3 shows the reduced frame error ratio (FER) for a given carrier to interference ratio.

The theoretical basis of the calculation of the reliability values as claimed in claim 2 will be described in detail hereinafter.

To this end, during a first step a simple binary transmission system is considered that assigns the amplitude values −a0 and +a0 to the binary information symbols “0” and “1”. For the sake of simplicity it is assumed that the resultant pulse response of the transmission system, including the transmission pulse shape filter, the pulse response and the receiving filter, has a Nyquist characteristic, which means that no intersymbol interference due to neighboring symbols should occur in the ideal sampling grid. The noise is assumed to be additive white Gaussian noise (AWGN). When the receiving filter is assumed to be a whitened matched filter, the noise values sampled at the symbol distance Ts are also statistically independent (white).

When the signal x[k], sampled at the ideal sampling rate, is now considered on the output of the receiving filter 540, the following conditional amplitude distribution density functions can be given for the amplitude values in conformity with FIG. 4:

Distribution density while assuming that a “0” was transmitted:

$$P ( x [ k ] \vert d [ k ] = 0 ) = \frac{1}{{σ}_{R} \sqrt{2 π}} exp ( - \frac{{( x [ k ] + {a}_{0} )}^{2}}{2 {σ}_{R}^{2}} )$$

Distribution density while assuming that a “1” was transmitted:

$$P ( x [ k ] \vert d [ k ] = 1 ) = \frac{1}{{σ}_{R} \sqrt{2 π}} exp ( - \frac{{( x [ k ] - {a}_{0} )}^{2}}{2 {σ}_{R}^{2}} )$$

Therein

Φ_{R}²: noise power of the real receiving signal

d[k]: binary information symbol with timing pulse k

x[k]: sampled real signal value received with timing pulse k

a0: noise-free receiving amplitude.

FIG. 4 illustrates the likelihood that a received real signal value x[k] sampled at the instant k occurs, subject to the condition that the transmitted binary information symbol, modulated with a bipolar modulation method, was either a “0” or a “1”. For example, when the amplitude of the received signal sampled at the instant k has the value X0[k], the likelihood therefor amounts to P (X0[k]|d[k]=0) if a binary β was transmitted. On the other hand, the likelihood therefor amounts to P(X0[k]|d[k]=1) if a binary 1 was transmitted.

Log-Likelihood ratio values should be used as a reliability measure q[k]:

$$q [ k ] = log ( \frac{P ( d [ k ] = 1 \vert x [ k ] )}{P ( d [ k ] = 0 \vert x [ k ] )} )$$

Using the identity

$$P ( A , B ) = P ( A \vert B ) \cdot P ( B ) = P ( B \vert A ) \cdot P ( A ) or$$

$$P ⟨ A \vert B ⟩ = P ⟨ B \vert A ⟩ \times \frac{P ( A )}{P ( B )}$$

the reliability measure can be converted into:

$$\begin{matrix}q [ k ] = log ( \frac{P ( x [ k ] \vert d [ k ] = 1 ) \cdot P ( d [ k ] = 1 )}{P ( x [ k ] \vert d [ k ] = 0 ) \cdot P ( d [ k ] = 0 )} ) \\ = log ( \frac{P ( x [ k ] \vert d [ k ] = 1 )}{P ( x [ k ] \vert d [ k ] = 0 )} ) + log ( \frac{P ( d [ k ] = 1 )}{P ( d [ k ] = 0 )} )\end{matrix}$$

When equal likelihoods are assumed for the binary information symbols, the second term is eliminated and, after some transformations, there remains:

$$q [ k ] = log ( \frac{P ( x [ k ] \vert d [ k ] = 1}{P ( x [ k ] \vert d [ k ] = 0} ) = 2 \cdot \frac{{a}_{0}}{{σ}_{R}^{2}} \cdot x [ k ]$$

Therein, α₀²/Φ_{R}² is the mean signal-to-noise ratio (S/N) determining the mean bit error likelihood.

This result should be applied to the case of differential detection of a DQPSK modulated receiving signal (see FIG. 5). It is assumed that the complex signal values sampled with he symbol distance Ts after the receiving filter are denoted by the reference r[k] and that they consist of the noise-free signal value s[k] and the noise value n[k]:

r[k]=s[k]+n[k]

After the differentiation, the signal values rd[k] are obtained in conformity with:

$$\begin{matrix}rd [ k ] = r [ k ] \cdot {r}^{*} [ k - 1 ] = ( s [ k ] + n [ k ] ) \cdot ( {s}^{*} [ k - 1 ] + {n}^{*} [ k - 1 ] ) \\ = s [ k ] \cdot {s}^{*} [ k - 1 ] + s [ k ] \cdot {n}^{*} [ k - 1 ] + n [ k ] \cdot {s}^{*} [ k - 1 ] + n [ k ] \cdot {n}^{*} [ k - 1 ] \\ = sd [ k ] + nd [ k ]\end{matrix}$$

Therein, sd[k] is the ideal, noise-free signal value and nd[k] is the noise value each time after the differentiation:

$$sd [ k ] = s [ k ] \cdot {s}^{*} [ k - 1 ]$$

$$nd [ k ] = s [ k ] \cdot {n}^{*} [ k - 1 ] + n [ k ] \cdot {s}^{*} [ k - 1 ] + n [ k ] \cdot {n}^{*} [ k - 1 ]$$

Therefore, the noise power Φ_{d}² after the differentiation for the time-invariant AWGN channel is:

$$\begin{matrix}{σ}_{d}^{2} = E \{ {\vert s [ k ] \cdot n * [ k - 1 ] + n [ k ] \cdot s * [ k - 1 ] + n [ k ] \cdot n * [ k - 1 ] \vert}^{2} \} \\ = 2 * {\vert s [ k ] \vert}^{2} * {σ}_{c}^{2} + {σ}_{c}^{4}\end{matrix}$$

Assuming that the noise power Φ_{c}² is usually significantly smaller than the signal power, the noise power after the differentiation is approximately:

Φ_{d}²≈2·|S[k]|²·Φ_{c}²

When the bit decision is then considered subject to the condition that the noise-free signal values sd[k] are situated on the ±45° axes in the signal space (π/4 DQPSK), the situation shown in FIG. 5 arises. a₀ can be substituted by

$$\frac{1}{\sqrt{2}} \cdot {\vert s [ k ] \vert}^{2} , {σ}_{R}^{2} by {σ}_{d}^{2} / 2$$

(real noise power component) and x[k] by Re{rd[k]} or Im{rd[k]}, so that ultimately the following expressions are obtained as reliability values for the two binary information symbols of a quaternary symbol:

$$q [ 2 k ] = 2 \cdot \frac{{a}_{0}}{{σ}_{R}^{2}} \cdot x [ k ] = 2 \cdot \frac{{\vert s [ k ] \vert}^{2} \cdot Re \{ {r}_{d} [ k ] \}}{\sqrt{2} \cdot {\vert s [ k ] \vert}^{2} \cdot {σ}_{c}^{2}} = \sqrt{2} \cdot \frac{Re \{ {r}_{d} [ k ] \}}{{σ}_{c}^{2}}$$

$$q [ 2 k + 1 ] = \sqrt{2} \cdot \frac{Im \{ {r}_{d} [ k ] \}}{{σ}_{c}^{2}}$$

Thus, the real component and the imaginary component of the differential signal values, normalized with the noise power of the complex signal prior to the differentiation, are obtained as approximately optimum reliability values.

1. A receiver for receiving a receiving signal which includes information symbols r[k] that have been modulated in conformity with the differential quaternary phase shift keying (DQPSK) principle and additionally channel encoded after their transmission via
a channel (530), which receiver is provided with
a receiving device (540) for receiving the receiving signal,
a phase detector (550) for determining the phase difference between two successive information symbols r[k],
a detection device (560′) for generating demodulated information symbols d[n] by incoherent differential detection of the receiving signal,
a calculation device (570′) for calculating, on the basis of the phase difference determined,
reliability values q[k] for the individual demodulated but still channel-encoded information symbols d[n], and
a channel decoding device (580′) for decoding the channel encoded information symbols d[n] while taking into account the calculated reliability values q[k], characterized in that
the reliability values q[k] are normalized to a reference quantity that is based on the noise power of the receiving signal.

2. A receiver as claimed in claim 1, characterized in that
the calculation device (570′) calculates the reliability values q[k] from two successively received information symbols r[k−1], r[k] as follows:
$$q [ 2 k ] = C \cdot \frac{Re \{ {r}_{d [ k ]} \}}{{σ}_{c}^{2}} and$$
$$q [ 2 k + 1 ] = C \cdot \frac{Im \{ {r}_{d [ k ]} \}}{{σ}_{c}^{2 }}$$
where r_{d}[k]=r[k]r*[k−1], where r*[k] is the conjugate complex information symbol for r[k],
where C=constant and
where Φ_{c}² is the noise power of the receiving signal.

3. A transmission system, notably a mobile radio system, which includes a transmitter (510, 520) for the transmission, via a channel (530), of information symbols that have been modulated in conformity with the differential quaternary phase shift keying (DQPSK) principle and additionally channel encoded, and also includes the receiver claimed in claim 1 or 2.

4. A method of decoding a receiving signal which includes information symbols r[k] that have been modulated in conformity with the differential quaternary phase shift keying (DQPSK) principle and additionally channel encoded, which method includes the following steps:
receiving the receiving signal after its transmission via the channel (530) of a transmission system,
calculating a reliability value q[k] for the logic level of each information symbol r[k] received,
demodulating the information symbols r[k] in conformity with the incoherent differential detection principle and generating demodulated but still channel encoded information symbols d[n], and
decoding the channel encoded information symbols d[n] while taking into account the calculated reliability values q[k], characterized in that
the reliability values q[k] are normalized to a reference quantity that is based on the noise power of the receiving signal.
